(19) United States
(12) Patent Application Publication
(10) Pub. No.: US 2006/0049627 A1
(43) Pub. Date: Mar. 9, 2006

(54) Pipe joint gasket

(76) Inventor: Andrew J. Happel, Fort Wayne, IN (US)

Correspondence Address: BAKER & DANIELS LLP;111 E. WAYNE STREET, SUITE 800, FORT WAYNE, IN, 46802, US

(21) Appl. No.: 11/220,229

(22) Filed: Sep. 6, 2005

Related U.S. Application Data
(60) Provisional application No. 60/607,615, filed on Sep. 7, 2004.

(51) Int. Cl. F16L 49/00

(52) U.S. Cl. 285/230

(57) ABSTRACT

A gasket which may be cast in place within a concrete structure, such as a manhole riser or septic tank, for example, to seal a connection between a pipe and the concrete structure. The gasket includes a main body portion and a sealing portion which are made from different materials. The main body portion may be made of a substantially rigid material, such as a semi-rigid plastic, for example. The sealing portion, which is united with the body portion, may be made of a substantially resilient material, such as flexible plastic or a rubber-type material, for example. In this manner, the substantially rigid portion of the gasket provides for effective anchoring in a cast wall, and the substantially resilient portion is compressible to provide a robust seal with a pipe that is inserted through the gasket.

### CROSS REFERENCE TO RELATED APPLICATIONS

This application claims the benefit under Title 35, U.S.C. § 119(e) of U.S. Provisional Patent Application Ser. No. 60/607,615, entitled PIPE JOINT GASKET, filed on Sep. 7, 2004.

### BACKGROUND OF THE INVENTION

1. Field of the Invention

The present invention relates to gaskets for use in pipe joint applications in which a gasket seals a connection between an opening in a structure and a pipe extending through the opening.

2. Description of the Related Art

Pipe joint gaskets are well known in the art for sealing a pipe joint connection between a pipe and a structure to which the pipe is connected. In one particular application, a pipe joint is formed between a sewer pipe and a concrete manhole riser, for example, in which a sewer pipe is inserted through a gasket embedded within the concrete wall of the manhole riser. In other applications, pipe joints may be provided to connect pipes to septic tanks, for example, or may be provided in any other structure to which pipes are connected.

Pipe joint gaskets are typically made from relatively rigid materials, such as plastics, or alternatively, from relatively resilient materials, such as rubber or other elastomers. Gaskets made of plastics are usually injection or compression molded, while gaskets made of elastomers are typically compression molded or alternatively, are formed by cutting a length of extruded elastomeric material and securing the ends thereof to one another by vulcanization, adhesion, or another suitable manner to form an annular shaped gasket. Subsequently, the plastic or elastomeric gasket is mounted within an opening in a structure, typically by embedding a portion of the gasket in the structure when the structure is cast. Alternatively, an expansion band may be used to radially compress an elastomeric gasket into engagement with the interior wall of an opening in a cast structure.

When a pipe is inserted through the opening of a plastic gasket, the outer surface of the pipe engages an inwardly-extending sealing portion of the gasket to create a fluid tight seal between the pipe and the gasket. Specifically, in gaskets made of relatively rigid materials, such as plastics, an inwardly-extending sealing portion, or sealing blade, of the gasket engages the outer surface of the pipe in a deflecting or wiping manner to form a fluid tight seal.

Elastomeric gaskets may be sealed to pipes using separate clamping bands which externally clamp a sealing portion of the gasket to the outer surface of the pipe to effect a fluid tight seal between the gasket and the pipe. Alternatively, the gasket may include a inwardly-depending sealing lobe which is compressed between the pipe and the gasket body upon insertion of the pipe through the gasket, forming what is known as a “stab joint”.

Although elastomeric gaskets form robust, effective seals with pipes, a disadvantage of same is that elastomeric materials are typically expensive and therefore increase the cost of gaskets which are made of these materials. On the other hand, although plastic materials are less expensive, plastics are typically less flexible and/or compressible than elastomeric or rubber materials and may be less suitable for sealing pipes in certain applications.

What is needed is a gasket for providing a fluid tight connection between a pipe and a structure, which is an improvement over the foregoing.

### SUMMARY OF THE INVENTION

The present concept relates to a gasket which may be cast in place within a concrete structure, such as a manhole riser or septic tank, for example, to seal a connection between a pipe and the concrete structure. The gasket includes a main body portion and a sealing portion which are made from different materials. The main body portion may be made of a substantially rigid material, such as a semi-rigid plastic, for example. The sealing portion, which is united with the body portion, may be made of a substantially resilient material, such as flexible plastic or a rubber-type material, for example. In this manner, the substantially rigid portion of the gasket provides for effective anchoring in a cast wall, and the substantially resilient portion is compressible to provide a robust seal with a pipe that is inserted through the gasket.

The gasket may advantageously be manufactured using a two-shot injection co-molding process. In this method, the material for the main body portion is heated and injected into a mold die. Then, before the substantially rigid material fully cures, the cores in the mold die are moved and a second, substantially resilient material is injected into the die and molded to the substantially rigid material, the substantially resilient material forming the sealing portion of the gasket. This two-shot injection molding process allows the second material to form a firm structural bond with the first material before the first material completely cures.

In use, the gasket is placed within forms for casting within a concrete structure, wherein the gasket is held in place either by the concrete forms and a mandrel structure or by a concrete reinforcing structure, such as reinforcement bar structure or by a wire mesh. Prior to casting, the sealing portion of the gasket can be folded inwardly with respect to the main body portion of the gasket to protect it during the casting process. After the concrete has been poured and substantially cured, the forms are stripped away to expose the main body portion of the gasket firmly anchored in an opening cast in the concrete. Alternatively, materials other than concrete, and processes other than casting, may be used to form the structure. Further, the structure may be pre-formed prior to the attachment of the gasket. In such an embodiment, an expansion band may be used to compress the body portion of the gasket into sealing engagement with the interior wall of the opening.

In an exemplary embodiment, the main body portion, which is made of a substantially rigid material, includes an integral annular anchoring flange. The anchoring flange extends radially from the outside surface of the body portion and is enveloped by concrete during the casting process. The anchoring flange has a geometry that allows the gasket to be retained in place after the concrete has cured. Alternatively, in other embodiments, the anchoring flange is not integral with the body portion and can comprise a separate component that is secured to the main body portion through an adhesive or fasteners.

In one embodiment, the sealing portion of the gasket is foldable between a first position in which the sealing portion is folded radially inwardly with respect to the main body portion and a second position in which the sealing portion extends axially outwardly from the main body portion. In one exemplary application, the sealing portion of the gasket may remain in its folded-in condition if a pipe of a relatively smaller diameter is inserted through the gasket. In this configuration, the pipe radially outwardly compresses the sealing portion of the gasket against the main body portion thereby providing a compression seal or “stab joint”. In another exemplary use, the sealing portion of the gasket may be unfolded from its folded-in position to its extended position if a pipe of a relatively larger diameter will be inserted through the gasket. After the pipe has been inserted through the sealing portion of the gasket, an annular external clamping band may be used to clamp the sealing portion of the gasket to the outer surface of the pipe to provide a compressive, fluid tight seal between the gasket and the pipe.

Advantageously, the substantially rigid material of the main body portion stiffens the gasket in the gasket region that interfaces with concrete structure, while the substantially resilient material of the sealing portion provides flexibility in the gasket region that seals to the pipe. This design allows the gasket to rigidly hold its shape during the casting process whereas a gasket entirely made of a resilient material could potentially more easily deform from the weight of the wet concrete. Similarly, a gasket made of an entirely resilient material requires a mandrel to maintain the shape of the gasket during the casting process whereas the body portions of the present embodiments may be constructed of a sufficiently rigid material such that a mandrel may not be needed.

Furthermore, the present gasket, made of both substantially rigid and substantially resilient materials, is less expensive to construct than a gasket entirely made of a substantially resilient material, such as rubber, due to the higher costs of the substantially resilient materials. The anchoring flange of the present embodiments may also be made of the same substantially rigid material as the body portion and thus strengthen the connection between the gasket and the concrete structure to prevent the gasket from becoming dislodged. Further, the relatively resilient portion of the gasket allows the gasket to easily seal to a pipe via a clamped seal or compression seal whereas a gasket entirely made of a rigid material would be less able to conform to the shape and irregularities of a pipe.

In one form thereof, the present invention provides a gasket for providing a seal between a concrete structure and a pipe, the gasket including an annular main body portion having an anchoring flange projecting radially outwardly thereof, the main body portion formed of a first material; and an annular sealing portion unitarily bonded to the main body portion and disposed radially inwardly of the main body portion, the sealing portion formed of a second material which is more flexible than the first material.

In another form thereof, the present invention provides a gasket for providing a seal between a structure and a pipe, the gasket including an embedment portion having an anchoring flange projecting therefrom, the embedment portion formed of a first, relatively rigid material; and a sleeve bonded to the embedment portion, the sleeve formed of a second, relatively resilient material which is more flexible than the first material, the sleeve including a pipe engaging portion.

### BRIEF DESCRIPTION OF THE DRAWINGS

The above-mentioned and other features and objects of this invention will become more apparent and the invention itself will be better understood by reference to the following description of embodiments of the invention taken in conjunction with the accompanying drawings, wherein:

FIG. 1 is a perspective view of a gasket in accordance with an embodiment of the present invention;

FIG. 2 is a sectional view of the gasket of FIG. 1 taken along line 2-2 of FIG. 1;

FIG. 3 is a partially sectioned perspective view of a pipe joint, including a gasket mounted in a concrete structure, the sealing portion of the gasket clamped to a pipe to form a seal therebetween;

FIG. 4 is a sectional perspective view of a gasket mounted in a concrete structure wherein the sealing portion of the gasket is configured in an extended or second position;

FIG. 5 is a partially sectioned perspective view of a gasket mounted within a structure with the sealing portion of the gasket folded inwardly to a first position, and further showing a pipe being inserted through the gasket;

FIG. 6 is a partially sectioned perspective view showing a gasket mounted within a structure with the sealing portion of the gasket folded inwardly to a first position, and showing a pipe sealingly connected to the structure by the gasket;

FIG. 7 is a sectional view showing an exemplary manner in which a gasket is cast within a structure using forms positioned to confine the gasket and the concrete when casting the structure;

FIG. 8 is a sectional view illustrating a manner in which the gasket may be cast into a concrete wall according to another embodiment;

FIG. 9 is a perspective view of a gasket in accordance with another embodiment of the present invention; and

FIG. 10 is a sectional view of the gasket of FIG. 9 taken along line 10-10 of FIG. 9.

Corresponding reference characters indicate corresponding parts throughout the several views. Although the drawings represent embodiments of the present invention, the drawings are not necessarily to scale and certain features may be exaggerated in order to better illustrate and explain the present invention. The exemplifications set out herein illustrate preferred embodiments of the invention and such exemplifications are not to be construed as limiting the scope of the invention in any manner.

### DETAILED DESCRIPTION

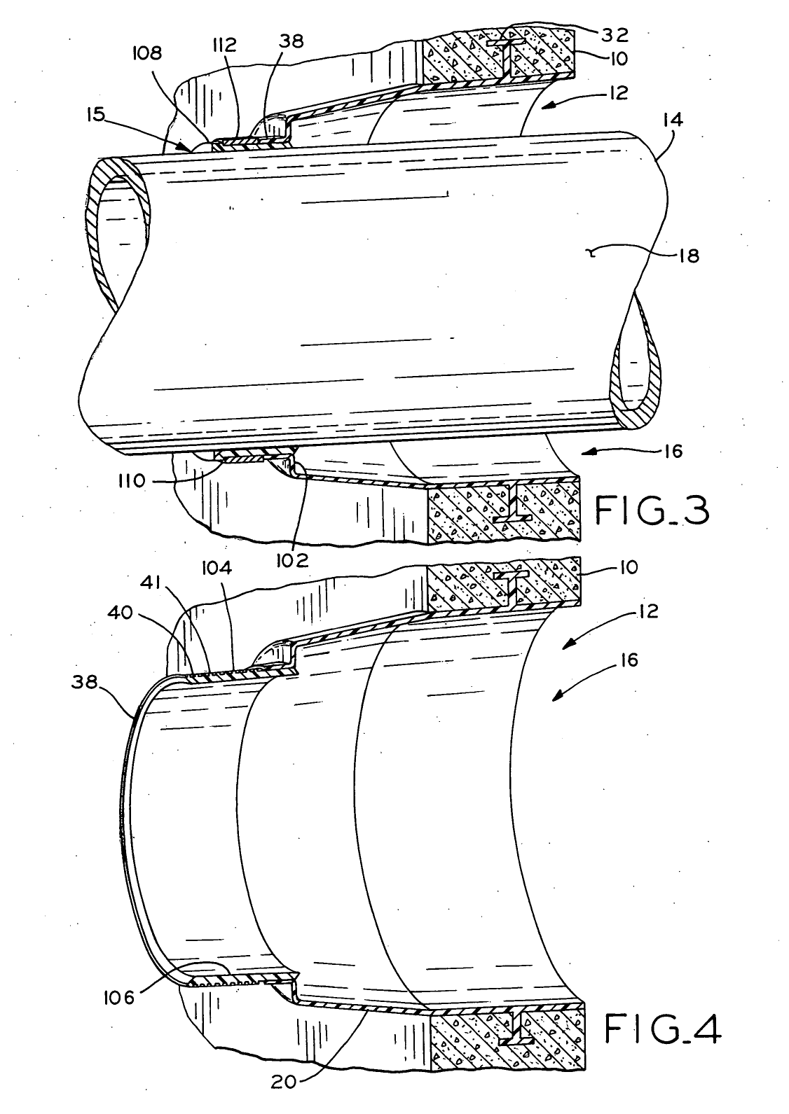

Referring first to FIG. 3, a pipe joint is shown, including a concrete structure 10 such as a manhole riser, in which at least a portion of gasket 12 is embedded. Concrete structure 10 is provided with opening 16 and gasket 12 is provided with opening 15 through which pipe 14 is received. Pipe 14 extends through gasket 12 and gasket 12 provides a fluid tight seal between concrete structure 10 and pipe 14. As described below, gasket 12 is constructed such that the fluid tight seal between structure 10 and pipe 14 is maintained even if the diameter of pipe 14 varies slightly from the diameter of opening 15 of gasket 12, or if pipe 14 is angled as it extends through opening 15. Opening 15, and thus gasket 12 and pipe 14, may have any suitable diameter, depending on the particular application.

Although the pipe joint application shown in FIG. 3 and described below is between a pipe and a concrete structure such as a manhole riser, the present gasket may generally be used in any application in which a pipe is mounted through an opening within the wall of a structure. Also, although structure 10 is illustrated and described below as being formed from concrete, structure 10 may alternatively be formed from other suitable materials, such as iron, steel, or plastic, for example.

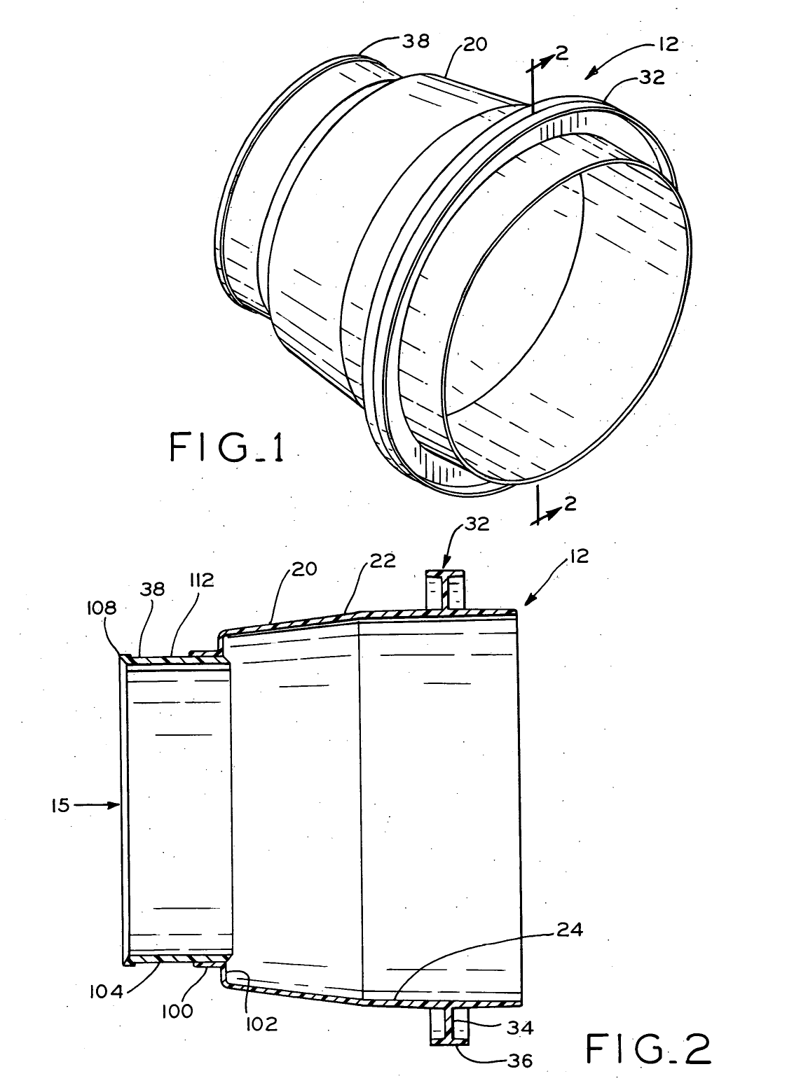

As illustrated in FIGS. 1 and 2, gasket 12 includes main body portion 20 and sealing portion 38 wherein each of these portions is made from a different material. Body portion 20 is made of a substantially rigid material, such as a semi-rigid plastic, for example. Suitable materials for body portion 20 include polypropylene (PP), low density polyethylenes (LDPE), and other thermoplastics, available from many commercial sources. Anchoring flange 32 extends perpendicularly from exterior surface 22 of body portion 20 and is embedded in concrete structure 10. Flange 32 is integrally formed with body portion 20 and includes neck portion 34 and end portion 36.

Sealing portion 38, which is bonded to, or united with, body portion 20 in the manner described below, is made of a substantially resilient material, such as a flexible plastic or a rubber-type material, for example. Suitable materials for sealing portion 38 include thermoplastic rubbers, or thermoplastic vulcanizates (“TPVs”), such as Santoprene™, available from Advanced Elastomer Systems, an affiliate of ExxonMobil Chemical. TPV materials can include cured ethylene propylene dimonomer (“EPDM”) rubber which helps to give the TPV materials rubber-like properties, such as flexibility and compressibility with good material memory, i.e., the ability of the material to return to its original shape after deformation or compressive forces are removed.

As discussed above, main body portion 20 is comprised of a substantially rigid material and sealing portion 38 is comprised of a substantially resilient material. In this embodiment, for example, the modulus of elasticity of the relatively resilient material of sealing portion 38, such as Santoprene™ may be approximately 250-600 psi, 250-450 psi, or 250-350 psi, for example, while the modulus of elasticity of the relatively rigid material of body portion 20, such as polypropylene, is approximately 200,000 psi. In other embodiments, the modulus of elasticity of the main body portion material can be at least one order of magnitude higher than the modulus of elasticity of the sealing portion material.

An advantage of this design is that the substantially rigid material of body portion 20 stiffens the gasket in the region that interfaces with concrete structure 10 while the substantially resilient material of sealing portion 38 provides flexibility in the region that seals to pipe 14. The substantially rigid material of body portion 20 allows gasket 12 to hold its shape during the casting process whereas a gasket entirely made of a resilient material could potentially deform from the weight of wet concrete. Additionally, integral anchoring flange 32 is also comprised of the same substantially rigid material as body portion 20 and thus this material strengthens the connection between gasket 12 and concrete structure 10. As the integral anchoring flange and body portion are comprised of a substantially rigid material, these portions of gasket 12 are less susceptible to deformation as compared to a gasket entirely made of an elastomeric material, while the substantially resilient material of sealing portion 38 also allows gasket 12 to effectively seal to pipe 14.

Gasket 12 is preferably manufactured according to a two-shot injection co-molding process. Such a process can be performed using a Ube two-shot injection molding machine, available from Ube Machinery of Ann Arbor, Mich. This machine includes two hoppers, each one for receiving a different material, and two injection sprues and nozzles which are connected to a mold die mounted in the machine. In this method, the substantially rigid material used to create main body portion 20 is heated and injected into the mold die through a first opening. In one embodiment, LDPE material is heated to approximately 3250 Fahrenheit and injected into the mold die. Then, before the substantially rigid material completely cures, the cores in the mold die are moved and a second, substantially resilient material is injected into the mold through a second opening. In the above-mentioned embodiment, Santoprene™ is heated to approximately 350-425° Fahrenheit when injected into the mold die. The second, relatively resilient material which forms sealing portion 38 of the gasket, upon curing with the first, relatively rigid material which forms body portion 20 of the gasket, becomes permanently bonded, molded, or united with to the body portion 20. Thus, the foregong two-shot injection molding process allows the second material to form a firm bond with the first material before the first material completely cures.

In the above-mentioned embodiment, the surface of the LDPE material is not permitted to cool below 180° Fahrenheit before the Santoprene™ material is injected such that the LDPE material and the Santoprene™ material can bond together, although the the chemistry of the foregoing bonding at the molecular lever is not fully known, it is thought that the LDPE material and Santoprene™ material form a firm physical bond upon curing, and perhaps also chemically bond with one another at the heated interface therebetween upon curing. As illustrated in FIG. 2, the bond between the substantially rigid material of body portion 20 and the substantially resilient material of sealing portion 38 occurs at the interface between a radially inwardly-depending lip 100 of body portion 20 and an outside surface 104 of sealing portion 38. Although not illustrated, the bonding surface area could be increased by allowing the resilient material to bond additionally to shoulder 102 and interior surface 24 of body portion 20. An increase in bonding surface area would increase the bond strength between body portion 20 and sealing portion 38.

Although the above process is the preferred method of manufacture, gasket 12 may also be formed by other suitable methods. For example, body portion 20 and sealing portion 38 may be co-extruded, cut, and subsequently folded into an annular configuration followed by securing the strip ends to one another by an adhesive or by a process in which the strip ends are heated, compressed together, and cooled. Alternatively, body portion 20 may be made by an injection molding process wherein body portion 20 and sealing portion 38 are subsequently united together by an adhesive or by a process similar to the heating process discussed above. On the other hand, body portion 20 and sealing portion 38 do not necessarily have to be united or bonded together. For example, the body and sealing portions may have a mating thread-like interface wherein the portions are screwed together and tightened to create a seal. Other methods by which gasket 12 may be formed will be apparent to those skilled in the art.

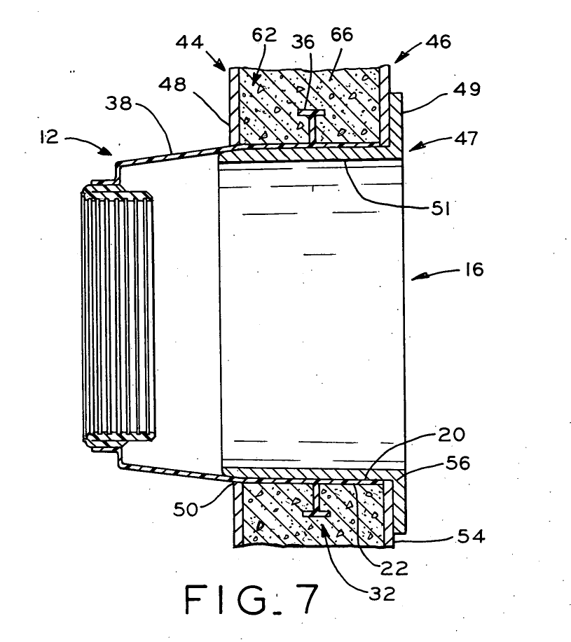

Referring to FIG. 7, gasket 12 is held in place during the casting of concrete structure 10 by a pair of forms 44 and 46. In some embodiments, mandrel 47 may be used to prevent body portion 20 from deforming due to the weight of the wet concrete. However, it is possible to construct body portion 20 from a material sufficiently rigid to withstand the weight of the wet concrete without deforming. In this embodiment, a mandrel is not necessary. However, in almost all embodiments, forms 44 and 46 are necessary to define the shape of the concrete and maintain the position of the gasket.

Forms 44 and 46 isolate exterior surface 22 of body portion 20 and anchoring projection 32 to prevent concrete from contacting the internal surfaces of gasket 12. Form 44 includes wall portion 48 having aperture 50 wherein the interior surface of aperture 50 contacts body portion 20 to create a seal to prevent wet concrete from flowing onto sealing portion 38. Form 46 includes wall portion 54 having aperture 56 wherein the interior surface of aperture 56 contacts body portion 20. Mandrel 47, which comprises annular member 51 and flange 47 attached to one end of annular member 51, extends inwardly into body portion 20. Annular member 51 engages the interior surface 24 of body portion 20 wherein the contour of annular member 51 substantially parallels the contour of interior surface 24. Flange 49 of mandrel 47 abuts form 46 to control the depth in which mandrel 47 is inserted into gasket 12. The void between forms 44 and 46 comprises an area 62 for receiving concrete 66 to form structure 10.

After gasket 12 is assembled with forms 44 and 46 and mandrel 47, concrete 66 or another suitable material is poured into area 62, filling area 62 around the outer surface of gasket 12. Concrete 66 surrounds anchoring projection 32 of gasket 12 to permanently embed anchoring projection 32 within concrete 66 and lock gasket 12 in position within opening 16 formed in concrete structure 10. Specifically, the portion of concrete 66 around the tapered neck portion 34 (FIG. 6) of anchoring projection 32 acts to lock gasket 12 in place, preventing removal of gasket 12 from concrete structure 10, as end portion 36 (FIG. 6) of anchoring projection 32 is too thick to pass through the opening defined by the concrete around neck portion 34 of anchoring projection 32. Forms 44 and 46 are removed after concrete 66 sets up and hardens wherein gasket 12 remains in position in concrete structure 10. Sealing portion 38 remains in its first position until a user manually unfolds same outwardly to its second position as described below. In this manner, sealing portion 38 is protected from damage during the shipping or handling of concrete structure 10.

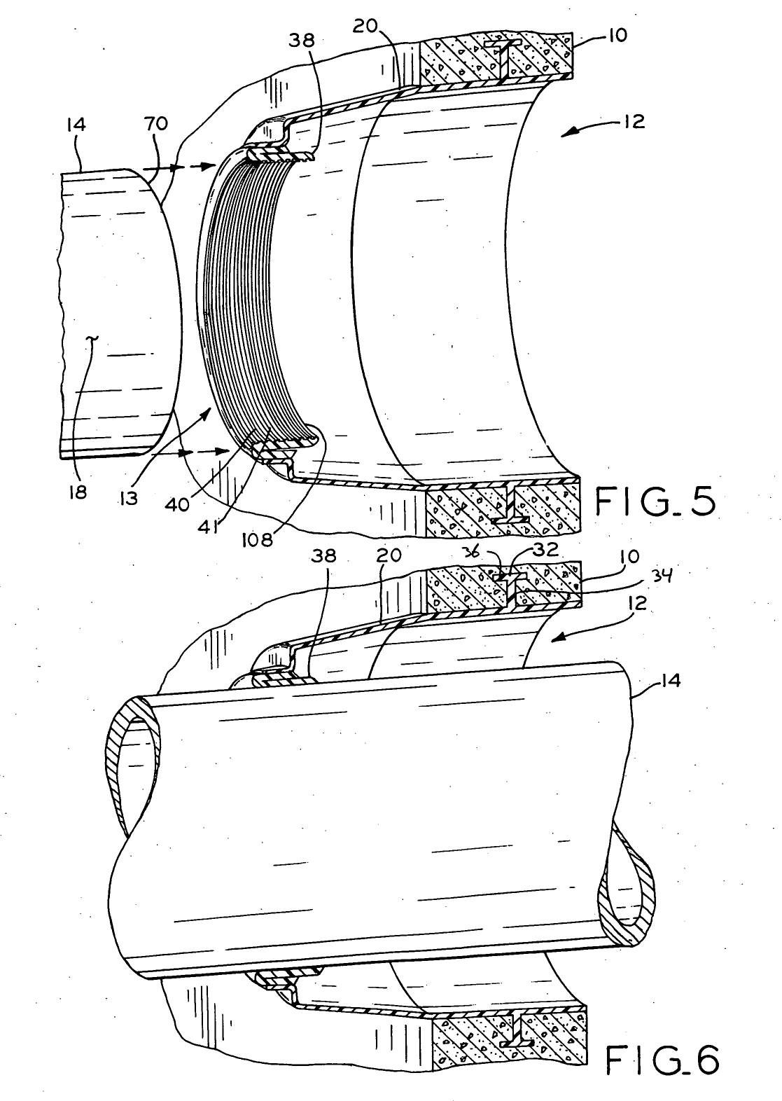

Sealing portion 38 of gasket is movable between a first position shown in FIG. 5 and a second position shown in FIG. 4. In this first position, a part of sealing portion 38 is folded radially inwardly with respect to body portion 20 such that lip 108 is brought inwardly towards the center of body portion 20. Sealing portion 38 is able to bend into this position as it is made of a substantially resilient material. Recesses 40, or annular notches, on outside surface 104 of sealing portion 38 provide hinge points about which sealing portion 38 may be folded. Each recess 40 is intermediate two ridges 41 wherein ridges 41 are compressed when pipe 14 is inserted through gasket 12. As illustrated in FIG. 5, sealing portion 38 is shown in its first position and is folded inwardly of body portion 20. Sealing portion 38 is stable in this first position, such that sealing portion 38 will remain in this position in the absence of external forces applied thereto. When end 70 of pipe 14 is inserted into gasket 12 in this first position, contact between outer surface 18 of pipe 14 and sealing portion 38 radially compresses sealing portion 38 against or toward body portion 20 thereby creating a seal between pipe 14 and sealing portion 38.

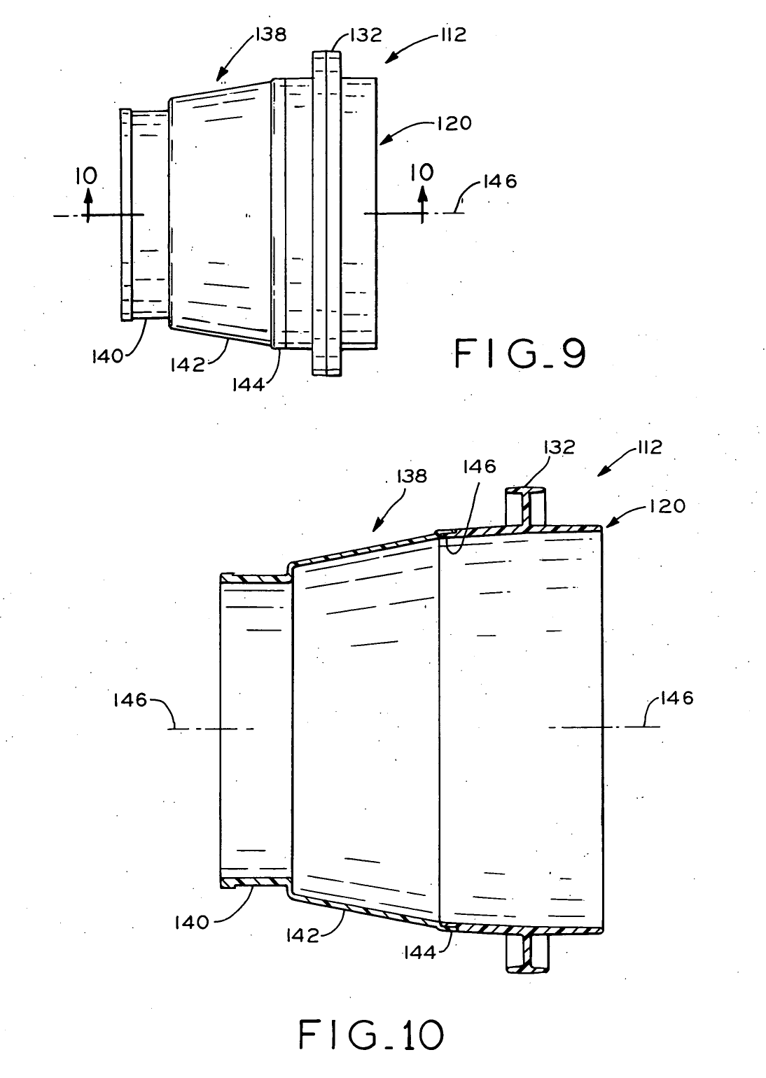

In another embodiment, gasket 112, illustrated in FIGS. 9 and 10, includes sealing portion 138 attached to main body portion 120. Main body portion 120 comprises an embedment portion having an annular anchoring flange 132 and connection portion 146 mounted to the inside surface of sealing portion 138. In this embodiment, sealing portion 138 comprises a sleeve having band seat 140, substantially conical portion 142, and connection portion 144 mounted to the outside surface of main body portion 120. This embodiment differs, in one respect, from the embodiment of FIGS. 1 and 2 in that sealing portion 138 of gasket 112 is longer along a longitudinal axis of gasket than main body portion 120, whereas in the embodiment of FIGS. 1 and 2, sealing portion 38 of gasket 12 is shorter along a longitudinal axis of gasket 12 than main body portion 20. More particularly, sealing portion 138 extends along longitudinal axis 146 for a distance longer than the distance main body portion 120 extends along axis 146. Sealing portion 138, owing to its larger flexible conical portion 142, can be easily flexed inwardly, as described above, between first and second positions.

The diameter of pipe 14 may vary slightly wherein the pipe diameter may not be exactly equal to the inner diameter of the inwardly folded sealing portion of gasket 12, illustrated as opening 13 in FIG. 5. For example, if the diameter of pipe 14 is slightly less than the inner diameter of opening 13, the above-described radial compression of sealing portion 38 may be somewhat lessened while still providing a fluid tight seal between gasket 12 and pipe 14. Alternatively, if the diameter of pipe 14 is slightly greater than opening 13, the above-described radial compression of sealing portion 38 is thereby increased providing a more robust fluid tight seal between gasket 12 and pipe 14.

In the second position of sealing portion 38, shown in FIG. 4, sealing portion 38 extends axially or longitudinally outwardly from body portion 20 of gasket 12. In this second position, sealing portion 38 is stable such that it will remain in this position in the absence of external forces applied thereto. When pipe 14 is inserted into gasket 12 in this second position, sealing portion 38 is expanded thereby creating a seal between pipe 14 and sealing portion 38. For any given embodiment of gasket 12, a pipe with a larger diameter will increase the expansion of sealing portion 38, thus increasing the seal pressure. However, a separate clamping band 112 (FIG. 3) may be necessary to clamp around band seat 110 of sealing portion 38 to increase the sealing pressure between pipe 14 and sealing portion 38, thus improving the seal. As illustrated in FIG. 3, annular lip 108 and shoulder 102 define the edges of band seat 110 and prevent clamping band 112 from slipping off sealing portion 38.

As an alternative to the above, gasket 12 may lack anchoring projection 32, wherein such a gasket is installed within a pre-formed opening in a structure using an internal expansion band assembly, for example, to compress the body of the gasket into sealing engagement with the wall of the opening. One such internal expansion band is disclosed in U.S. Published Patent Application No. 2004/0080118, assigned to the assignee of the present invention, the disclosure of which is expressly incorporated herein by reference.

Further, the first and second positions of sealing portion 38 need not necessarily be stable. For example, after sealing portion 38 of gasket 12 is folded inwardly to its second position, sealing portion 38 could be manually or otherwise held in that position until pipe 14 is inserted through gasket 12.

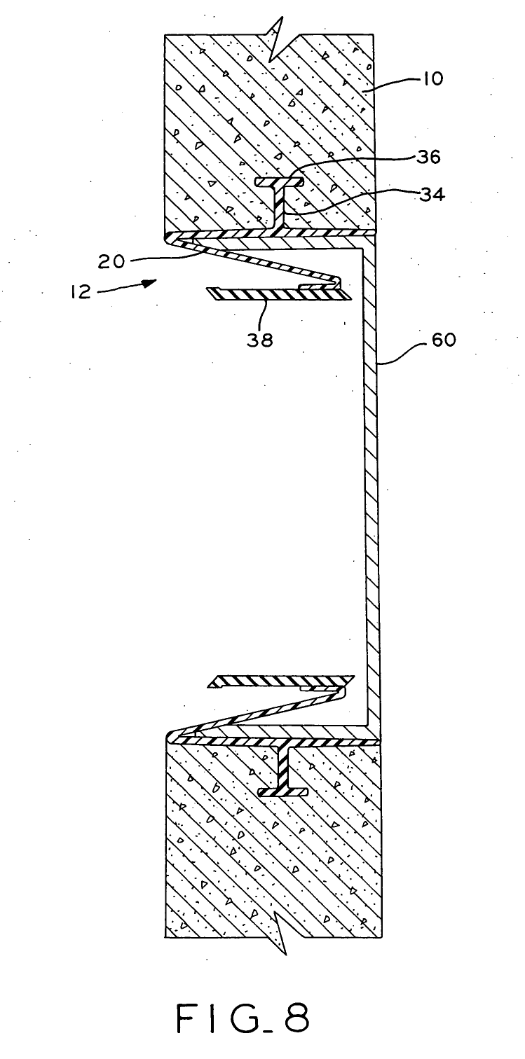

A method of casting gasket 12 in place according to an alternative embodiment is shown in FIG. 8. In this embodiment, body portion 20 of gasket 12 is made of a relatively rigid material; however, the material is resilient enough to allow bending or folding of body portion 20 radially inwardly as shown in FIG. 8. In this position, sealing portion 38 of gasket 12 is disposed radially inwardly of gasket 12 and is protected from possible contact with liquid concrete. When casting concrete structure 10, mandrel 60 is fitted into main body portion 20 of gasket 12 to support same, and forms (not shown) are positioned on either side of gasket 20. After the concrete is poured and hardens, the forms and mandrel 60 are stripped away, and body portion 20 of gasket is unfolded to the position shown in FIGS. 1-6. Thereafter, gasket 12 may be used to seal a pipe in the manner described above.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A gasket for providing a seal between a concrete structure and a pipe, said gasket comprising:
an annular main body portion having an anchoring flange projecting radially outwardly thereof, said main body portion formed of a first material; and
an annular sealing portion unitarily bonded to said main body portion and disposed radially inwardly of said main body portion, said sealing portion formed of a second material which is more flexible than said first material.

2. The gasket of claim 1, wherein said main body portion and said sealing portion are unitarily bonded to one another along an interface which extends circumferentially around a longitudinal axis of said gasket and which includes a component of length parallel to said longitudinal axis.

3. The gasket of claim 1, wherein said sealing portion includes an annular clamping band seat around a radial outer surface thereof.

4. The gasket of claim 1, wherein said sealing portion is foldable between a first position in which said sealing portion is folded axially inwardly with respect to said main body portion and a second position in which said sealing portion extends axially from said main body portion.

5. The gasket of claim 4, wherein said sealing portion includes an inside surface and an outside surface, wherein said inside surface is sealable against a pipe extending through said sealing portion in said first position, and wherein said outside surface is sealable against a pipe extending through said sealing portion in said second position.

6. The gasket of claim 1, wherein said sealing portion comprises a substantially conical section extending along a longitudinal axis of said gasket.

7. The gasket of claim 6, wherein said conical section extends along said axis for a first distance, wherein said main body portion extends along said axis a second distance, and wherein said first distance is one of substantially equal to or greater than said second distance.

8. The gasket of claim 1, wherein said sealing portion extends from said main body portion along an axis, wherein said sealing portion extends along said axis a first distance, wherein said main body portion extends along said axis a second distance, and wherein said first distance greater than said second distance.

9. The gasket of claim 1, wherein said main body portion includes an outside surface, and wherein said sealing portion is bonded to said outside surface.

10. The gasket of claim 1, wherein said sealing portion comprises a sleeve, said sleeve including a pipe engaging portion.

11. A gasket for providing a seal between a structure and a pipe, said gasket comprising:
an embedment portion having an anchoring flange projecting therefrom, said embedment portion formed of a first, relatively rigid material; and
a sleeve bonded to said embedment portion, said sleeve formed of a second, relatively resilient material which is more flexible than said first material, said sleeve including a pipe engaging portion.

12. The gasket of claim 11, wherein said embedment portion and said sleeve are bonded to one another along an interface which extends circumferentially around a longitudinal axis of said gasket and which includes a component of length parallel to said longitudinal axis.

13. The gasket of claim 11, wherein said sleeve includes an annular clamping band seat around a radial outer surface thereof.

14. The gasket of claim 11, wherein said sleeve is foldable between a first position in which said sleeve is folded axially inwardly with respect to said embedment portion and a second position in which said sleeve extends axially from said embedment portion.

15. The gasket of claim 14, wherein said sleeve includes an inside surface and an outside surface, wherein said inside surface is sealable against a pipe extending through said sleeve in said first position, and wherein said outside surface is sealable against a pipe extending through said sleeve in said second position.

16. The gasket of claim 11, wherein said sleeve comprises a substantially conical section extending from said embedment portion along a longitudinal axis of said gasket.

17. The gasket of claim 16, wherein said conical section extends from said embedment portion along said axis a first distance, and wherein said embedment portion extends along said axis a second distance, said first distance substantially equal to said second distance.

18. The gasket of claim 11, wherein said sleeve extends from said embedment portion along an axis, wherein said sleeve extends along said axis a first distance, wherein said embedment portion extends along said axis a second distance, and wherein said first distance is greater than said second distance.

19. The gasket of claim 11, wherein said embedment portion includes an outside surface, and wherein said sleeve is bonded to said outside surface.
